(19) United States
(12) Patent Application Publication
(10) Pub. No.: US 2010/0044293 A1
(43) Pub. Date: Feb. 25, 2010

(54) SEALING FOR LIQUID FILTER

(75) Inventors: Gregory J. Fisher, Kearney, NE (US); Daniel P. Pokorney, Gibbon, NE (US)

Correspondence Address: REINHART BOERNER VAN DEUREN P.C., 2215 PERRYGREEN WAY, ROCKFORD, IL, 61107, US

(73) Assignee: Baldwin Filters, Inc., Kearney, NE (US)

(21) Appl. No.: 12/581,459

(22) Filed: Oct. 19, 2009

Related U.S. Application Data
(63) Continuation of application No. PCT/US2008/059152, filed on Apr. 2, 2008.
(60) Provisional application No. 60/913,214, filed on Apr. 20, 2007.

(51) Int. Cl. B01D 35/30; B23P 11/00

(52) U.S. Cl. 210/232; 29/428

(57) ABSTRACT

The present disclosure pertains to a fluid filter having a mounting member such as a nut plate which may take the form of a nut plate assembly carrying a seal member. An annular bead is formed into the canister and engages the seal member. The seal member is disposed between the nut plate and the canister.

### CROSS-REFERENCE TO RELATED PATENT APPLICATIONS

This patent application is a continuation of co-pending PCT Application No. PCT/US2008/059152, filed Apr. 2, 2008, which claims the benefit of U.S. Provisional Patent Application No. 60/913,214, filed Apr, 20, 2007, the entire teachings and disclosure of which are incorporated herein by reference thereto.

### FIELD OF THE INVENTION

This invention generally relates to a fluid filter and more particularly related to the sealing mechanism employed between the canister and mounting member of such fluid filters.

### BACKGROUND OF THE INVENTION

Hydraulic spin on filters are well known in the art as is exemplified by U.S. Pat. No. 5,104,537, to Stifelman et al. entitled “High Pressure Hydraulic Spin-On Filter”; or U.S. Pat. No. 5,906,740 to Brown entitled “Spin-On Filter With Improved Retaining Groove.” Such filters require a sealing mechanism typically at the outer periphery of the filter to eliminate a bypass path between the metal canister of the filter and the mounting member which is often referred to as a base plate or nut plate. One issue that can arise is that during application of pressure within the filter, the pressure tends to push the can away from the mounting member thereby creating a potential leak path between the mounting member and the canister.

### BRIEF SUMMARY OF THE INVENTION

One aspect of the present invention is directed toward the formation of an annular bead into the end portion of the metal canister in a manner that circumferentially engages a ring seal member. A filter accomplishing this aspect includes a metal canister having an annular sidewall with an end portion. A mounting member (which may comprise one piece or an assembly of pieces) is mounted to the metal canister. The mounting member includes a thread and an opening for facilitating mounting of the filter and for fluid communication into and/or out of the canister. An annular groove is formed into the mounting member. A ring seal member is disposed in the groove and an annular bead which is formed into the end portion of the metal canister circumferentially engages the ring seal member.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-section of a fluid filter in accordance with an embodiment of the present invention, the cross-section being taking about line 1-1 of FIG. 2;

FIG. 2 is an end view of the filter shown in FIG. 1;

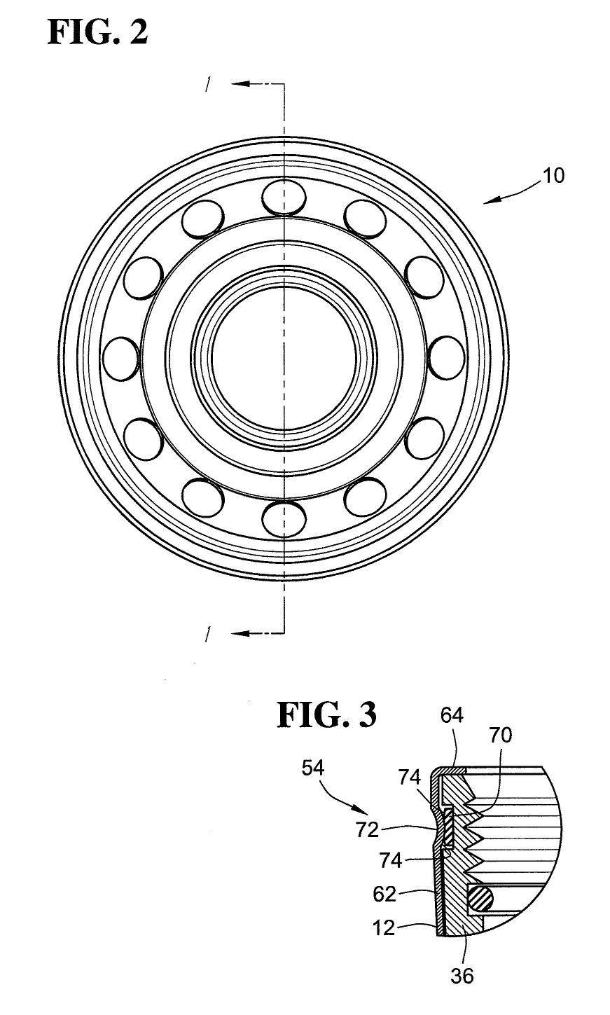

FIG. 3 is an enlarged view of a portion of FIG. 1 taken about circle A;

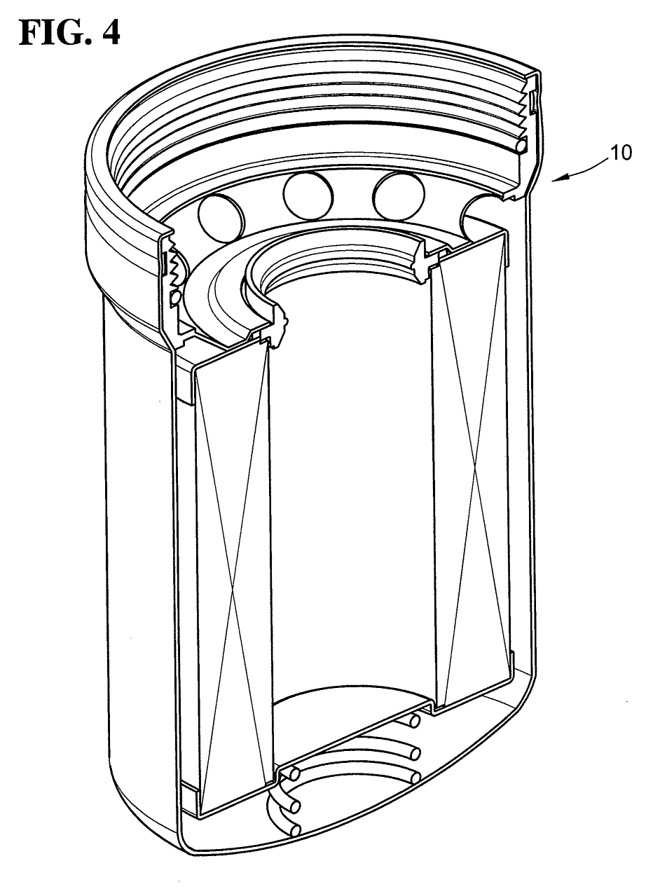

FIG. 4 is an isometric cross-sectional view of the filter shown in the previous figures;

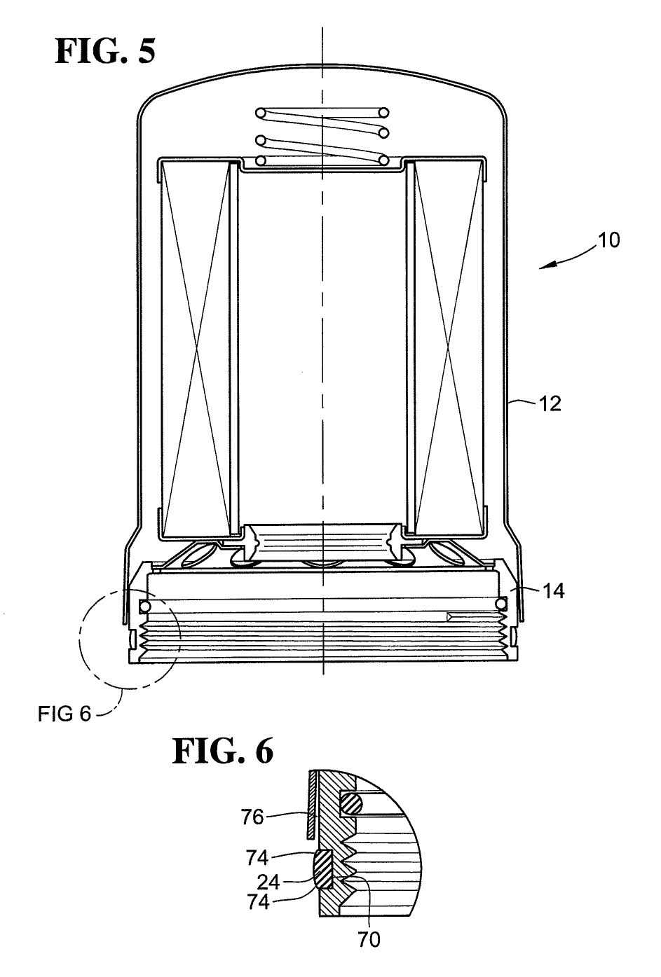

FIGS. 5 through 8 are cross-sectional views showing the progressive assembly of the filter and manufacturing steps to achieve the filter shown in FIG. 1.

### DETAILED DESCRIPTION OF THE INVENTION

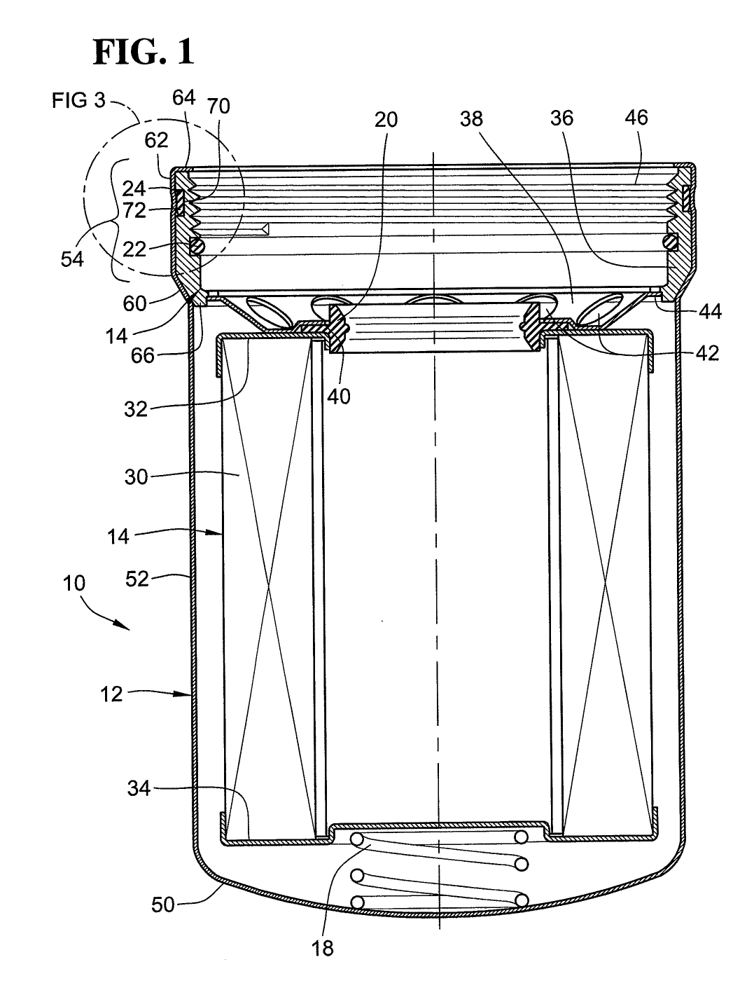

Referring to FIG. 1, an embodiment of a fluid filter is shown in the form of hydraulic filter 10 which is utilized in hydraulic filtering operations in order to separate particulates or other impurities from hydraulic working fluid. Such hydraulic operations can experience high normal operating pressures well in excess of 100 PSI and in some instances in excess of 1,000 PSI. However, it will be readily appreciated that the disclosed features may also be employed in other lower pressure fluid filter applications such as lub filters or the like.

The hydraulic filter as shown includes the following component parts: a metal canister (typically deep drawn formed from sheet steel), a nut plate which may take the form of nut plate assembly 14 and internal filter element 16, a spring 18, two inner seals 20 and 22 and an outer seal 24.

The filter element 16 includes a tubular ring of filter media 30 such as pleated cellulose based filter paper or other appropriate filter media and a pair of end caps 32 and 34 sealingly bonded to opposing ends of the filter media 30. The upper end cap 32 is open to allow for fluid flow into and out of the filter element 16, while the lower end cap 34 is closed and may have a recess as shown for receipt of the spring 18. The spring 18 acts on the lower end cap 34 to urge the filter element 16 toward the nut plate assembly 14. The smaller inner seal 20 surrounds the opening in the upper end cap 32 so as to provide a seal to prevent fluid communication between a dirty fluid inflow and a clean fluid outflow when in use with a fluid circuit (e.g. when the filter is threadably attached to a mounting stub of an engine or hydraulic system).

The nut plate may either be a single component part or may include an assembly of different component parts as is shown, thus taking the form of a nut plate assembly 14. Such a nut plate or nut plate assembly 14 provides a mounting member for securing the filter 10 onto the mounting stub of a fluid circuit which typically includes concentric pipes (not shown) which have an outlet port to provide unfiltered fluid to the filter element and an inlet return port for collecting the fluid that has been filtered by passing through the hydraulic filter 10. For hydraulic filter applications, typically the nut plate will comprise one or more stamped steel components or aluminum cast component, or a combination thereof.

The nut plate assembly 14 as shown includes a formed threaded steel ring 36 stacked on top of a perforated sheet steel spacer plate 38. The spacer plate 38 includes a central opening to provide for either an inlet or outlet port and a plurality of radial ports 42 to provide for fluid communication with the outside of the filter element 16. The other inner seal 22 may be retained along an inner groove formed into the ring member 36. The ring member 36 may also define an annular cutout 44 to facilitate stacking and/or alignment of the spacer plate 38 and the steel ring member 36. Finally, the ring member 36 is shown to include threading to facilitate screw-on attachment of the filter 10 to a filter circuit (not shown).

As shown, the canister includes a closed domed end 50 which is connected to an annular and more specifically cylindrical side wall 52 which in the unassembled state includes an open end at the end opposite the domed end 50. An end portion 54 of the cylindrical side wall is provided for facilitating securement of the canister 12 to the nut plate assembly 14 and/or sealing of the canister 12 with the nut plate assembly 14.

In greater detail, the end portion 54 of the present embodiment includes an outwardly formed annular conical section 60, a relatively annular straight section 62 and a folded over section 64. The folded over section 64 may form either an L-lock or J-lock with the threaded ring member 36 to thereby secure the nut plate 14. The folded over section 64 more specifically engages a radially extending face or portion of the ring member 36. The conical section 60 engages a tapered underside 66 of the ring member 36 so as to trap the ring member 36 to the canister 12 to thereby prevent relative axial movement therebetween, and also ensures that the L-lock or J-lock provides adequate securement.

An annular groove 70 is formed into the threaded ring member 36 preferably at the outer periphery thereof along the outermost cylindrical surface of the ring member 36. The outer seal 24 is disposed within the groove 70 so as to prevent leakage between the annular interface between the canister and the nut plate and particularly the ring member 36. In accordance with the present invention, the end portion of the canister 12 is deformed inwardly about its circumference that provides an annular bead 72 that circumferentially engages the seal 24 disposed in the groove 70. Preferably, the annular bead 72 compresses the seal and keeps the seal 24 in a state of compression. Further, the annular bead 72 preferably enters into and extends into the groove 70 partially but is spaced sufficiently from the groove bottom. The apex of the annular bead 72 is approximately centered upon the seal 24 and/or the groove 70. Each of these aspects maximize the improvement in sealing characteristics that are achieved with the hydraulic filter 10. The annular bead 72 may be formed (but not necessarily) by a beading operation in which the canister is spun relative to a tool so as to inwardly deform the end portion of the canister into the seal 24 and groove 70.

Several advantages may be realized with the present invention. In a filter that uses such an L or J lock configuration, the assembly of parts can be difficult and often the seal can be accidentally cut or removed during the assembly process and the canister or the base plate often require tapered lead ends on either, or both, of the parts so as to reduce the possibility of accidentally pealing the seal off of the base plate. The seaming process can also contribute to inconsistencies that can affect the sealing ability of the filter assembly. While such tapered parts are typically required to properly assemble the parts of the filter to decrease the possibility of cutting or accidentally removing the seal during the assembly process, such tapers can be counterproductive in the function of the filter once assembled. In particular, the taper leaves effectively some tolerance or a gap between the base plate and the canister that can increase the likelihood of leaking during service. Further, seaming processes, whether it be an L-lock or J-lock, can also create a similar gap or even worsen an existing gap between the nut plate and the canister, especially on thinner walled canisters. Such a seaming process can contribute to the increased inconsistencies around the sealing area resulting in a large deviation in pressure holding ability.

The advantage of the annular bead 72 is that it properly compresses the seal 24 and increases the consistency of the sealing area and the pressure holding ability of the filter while in service. In fact, considering that thinner walled canisters are subject to greater deflection potential than thicker walled cans, this feature can provide for thinner walled metal canisters to be used and formed resulting in manufacturing and cost reductions for a given application.

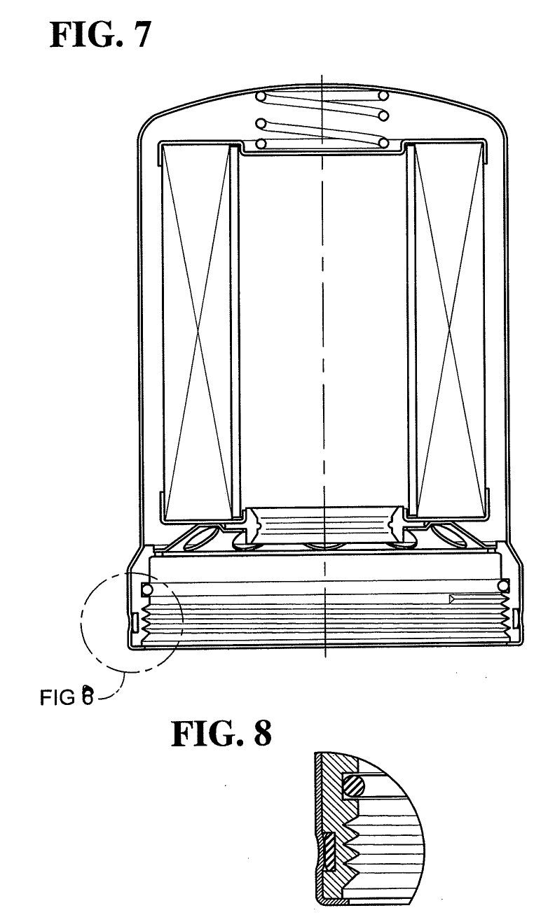

To show some of these aspects, the assembly views of FIGS. 5-8 showing the progression of the hydraulic filter 10 to the assembled state in FIG. 1 are illustrated. It can be seen that the seal 24 includes a taper 74 (and preferably two tapers to make the seal useable either way) and that the canister 12 end portion 54 prior to assembly is tapered outwardly slightly at 76.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter, comprising:
a metal canister having an annular sidewall with an end portion;
a mounting member mounted to the metal canister, the mounting member including a thread and an opening for facilitating mounting the filter and fluid communication;
filter media arranged in the metal canister;
an annular groove formed into the mounting member;
a ring seal member disposed in the groove; and
an annular bead formed into an end portion, the annular bead circumferentially engaging the ring seal.

2. The filter of claim 1, wherein the mounting member is a nutplate having an outer ring portion, the end portion generally surrounding the outer ring portion with a terminating section folded over the nutplate to axially secure the canister to the nutplate.

3. The filter of claim 2, further including a necked down region formed into the sidewall joining the end portion to a remainder of the annular sidewall of the metal canister, and wherein the outer ring portion is sandwiched axially between the necked down region and the terminating section.

4. The filter of claim 3, wherein the necked down region is a continuous annular conical section.

5. The filter of claim 4, wherein the terminating section provides one of a L-lock or J-lock attachment to the outer ring portion.

6. The filter of claim 5, wherein the nutplate comprises an assembly of components including a ring member providing the outer ring portion and a perforated spacer plate, the nutplate and the ring member formed of steel material with the ring member being of thicker steel gauge material.

7. The filter of claim 1, wherein the annular bead extends partially into the annular groove in spaced relation to a bottom of the groove, and wherein the annular bead compresses the ring seal radially against the bottom of the groove.

8. The filter element of claim 7, wherein the annular bead has a configuration resulting from a beading operation with an apex engage an outer cylindrical sealing surface formed on the seal.

9. The filter element of claim 8, wherein the seal further defines taper surfaces on either side of the outer cylindrical surface, and wherein the seal in a relaxed state has a radial thickness greater than a radial depth of the groove.

10. The filter of claim 1, wherein the filter is a hydraulic filter, wherein the metal canister and the mounting member are adapted and configured for hydraulic circuit pressure loads.

11. A method of manufacturing a filter, comprising:
forming a groove in an outer radial periphery of a nutplate;
placing a ring seal in the groove;
sliding a cylindrical sidewall of a canister over the outer radial periphery;
securing the canister to the nutplate with filter media arranged inside;
forming an annular bead into the cylindrical sidewall to compress the ring seal in the groove.

12. The method of claim 11, wherein the forming an annular beading comprises beading the annular bead into metal material of the canister by a spinning operation.

13. The method of claim 12, wherein the ring seal has a relaxed state projecting radially outside of the groove, wherein the seal has a taper to facilitate sliding the cylindrical sidewall over the seal.

14. The method of claim 11, further comprising folding end section over the outer radial periphery to secure the nutplate and the canister.

15. The method of claim 14, forming the folded end section into one of a J-lock and a L-lock to thereby secure the canister to the nutplate.

16. The method of claim 15, further comprising seating the nutplate on a necked down region formed into the canister and trapping the nutplate between the necked down region and the one of the J-lock and the L-lock.

17. The method of claim 11, further comprising arranging the filter media in a filter element including sealing ends of a ring of filter media with opposing endcaps and biasing the filter element toward the nutplate with a spring supported by a closed end of the canister.

18. The method of claim 11, further configuring the filter as a hydraulic filter that is adapted to carry pressure loads of a hydraulic circuit.
